(19) United States
(12) Patent Application Publication
(10) Pub. No.: US 2025/0358289 A1
(43) Pub. Date: Nov. 20, 2025

(54) DEVICES, SYSTEMS AND METHODS FOR PROVIDING ENHANCED, SECURE NETWORKING AND CONNECTIVITY FROM EDGE INFRASTRUCTURE

(71) Applicant: CyberLucent, Inc., Scottsdale, AZ (US)

(72) Inventors: Stephen R. MacEwen, San Clemente, CA (US); Heath Johns, Victoria (CA)

(21) Appl. No.: 19/120,402

(22) PCT Filed: Oct. 10, 2023
(86) PCT No.: PCT/US2023/076427

§ 371 Date: Apr. 11, 2025

Related U.S. Application Data
(60) Provisional application No. 63/415,492, filed on Oct. 12, 2022.

(51) Int. Cl. H04L 9/40

(52) U.S. Cl. CPC H04L 63/102; H04L 63/08

(57) ABSTRACT

There is described devices, systems, and methods for providing enhanced, secure networking and connectivity from edge infrastructure. The devices, systems and methods provide edge device capabilities that establish secure communication between one or more endpoint devices of a user and one or more network destinations. The capabilities include the use of distributed and synchronized user profiles associated with the user. The user profiles contain a plurality of networking parameters and metadata associated with the one or more endpoint devices and the one or more network destinations. The capabilities also include instantiating and configuring an active agent using information associated with the user profile to monitor and manage information flows to and from the one or more endpoint devices using information associated with the user profile.

### CROSS-REFERENCE TO PREVIOUS APPLICATION

This application claims priority from U.S. provisional patent application No. 63/415,492 filed on Oct. 12, 2022, which is incorporated herein by reference in its entirety.

### FIELD

The present disclosure generally relates to the field of data communications and networking. In particular, the present disclosure relates to devices, systems, and methods for providing enhanced, secure networking and connectivity from edge infrastructure.

### INTRODUCTION

The increasing ubiquity of remote work, combined with a sustained escalation in the number and the sophistication of cybersecurity threats, has caused security practices to evolve to the point where information flows require real-time and continuous monitoring and management.

Such functionality is typically provided by an active agent, i.e., a continuously running, autonomous piece of software that performs security functions in accordance with security policies. Such active agents may simply monitor and log information flow metadata, and/or take a more active role by encrypting, routing, attenuating, and/or filtering information flows. In order to actively monitor and manage information flows, active agents must be located on endpoint devices, inside a Virtual Private Network (VPN), or at the edge (entry point) of a network.

When an active agent is implemented on an endpoint device, such as a laptop computer, software is installed on each endpoint device which requires secure access to a service or other endpoint devices and that software acts as the active agent. While this solution provides several advantages in terms of performance, the need to install, update and support software on each endpoint device is complex, costly and precludes flexible deployment.

In situations in which endpoint devices are granted access to VPNs, active agents may form part of the software that creates the VPN, and/or the software installed on servers forming part of the same VPN. VPNs cause information flows to be routed in inefficient manners, and either require software or configuration to be placed on endpoint devices, thereby sharing the same disadvantage as non-VPN endpoint-based solutions.

With a view to addressing the problems associated with active agents being implemented on endpoint devices or on VPNs, active agents could be implemented on edge devices. While such implementations would solve many of the above problems relating to privacy and flexibility of deployment, edge device implementation poses significant technical challenges, as edge devices are typically not portable (e.g., requiring fixed configurations associated with fixed networking connections to access larger networks) and are composed of many different types of devices (i.e., routers, switches, laptops, smartphones, tablet computers, etc.).

As such, there is a clear need for improved devices, systems and methods for providing enhanced, secure networking and connectivity from edge infrastructure.

### SUMMARY

The various embodiments described herein generally relate to devices, systems, and methods for providing flexible, private, and seamless networking and connectivity from edge infrastructure.

In one aspect of the present disclosure, there is provided a method performed by an edge device to establish secure communication between one or more endpoint devices of a user and one or more network destinations. The method comprises connecting to an endpoint device of the one or more endpoint devices and identifying the endpoint device and sending an authentication request to a user associated with the endpoint device. The method also comprises receiving a user profile associated with the user, the user profile containing a plurality of networking parameters and metadata associated with the one or more endpoint devices and the one or more network destinations. The method also comprises establishing an isolated local network using information associated with the user profile, the isolated local network being established between the edge device and the one or more endpoint devices. The method also comprises instantiating and configuring an active agent using information associated with the user profile to monitor and manage information flows to and from the one or more endpoint devices using information associated with the user profile.

In some examples, the method further comprises establishing a secure communication link using information associated with the user profile, the secure communication link being established between the edge device and one of the one or more network destinations.

In some examples, the authentication request is made by way of a secure cloud platform and a secure application running on a communication device owned by the user.

In some examples, the method further comprises periodically receiving updated information associated with the user profile and reconfiguring the active agent to monitor and manage information flows to and from the one or more endpoint devices using the updated information associated with the user profile.

In some examples, the method further comprises disinstantiating the active agent when none of the one or more endpoint devices are connected to the edge device for a predetermined amount of time.

In some examples, the method is performed by an active agent manager running on the edge device.

In some examples, the active agent is implemented in a virtual machine or a container on the edge device.

In some examples, the active agent is further configured to generate and collect metadata relating to information flows to and from the one or more endpoint devices.

In some examples, the metadata includes one or more of timing and volumes of information flows, source and destinations of information flows, and the types of information being communicated.

In some examples, the active agent is further configured to create risk management profiles for each of the one or more endpoint devices based on the metadata.

In some examples, the active agent is further configured to manage information flows to and from the one or more endpoint devices by routing, encrypting, filtering, and/or attenuating the information flows based on analysis of the metadata.

In some examples, the active agent is further configured to generate alerts based on the analysis of the metadata.

In another aspect of the present disclosure, there is provided an edge device configured to execute the aforementioned method.

In yet another aspect of the present disclosure, there is provided a non-transitory computer program product comprising computer-implemented instructions to cause a computer system to execute the aforementioned method.

In yet another aspect of the present disclosure, there is provided a method for monitoring and managing secure communications to and from one or more endpoint devices. The method comprises receiving, from one or more active agents on one or more edge devices, respectively, networking parameters and metadata associated with information flows to and from the one or more endpoint devices. The method also comprises updating a user profile using the received networking parameters and metadata. The method also comprises sending information relating to the updated user profile to each of the one or more active agents, the one or more active agents being configured to monitor and manage communications to and from the one or more endpoint devices using information associated with the updated user profile.

In some examples, the one or more active agents are each implemented in a virtual machine or a container on an edge device.

In some examples, each active agent is further configured to generate and collect metadata relating to information flows to and from its respective one or more endpoint devices.

In some examples, the metadata includes one or more of timing and volumes of information flows, source and destinations of information flows, and the types of information being communicated.

In some examples, each active agent is further configured to create risk management profiles for each of the one or more endpoint devices based on the metadata.

In some examples, each active agent is further configured to manage information flows to and from the one or more endpoint devices by routing, encrypting, filtering, and/or attenuating the information flows based on analysis of the metadata.

In some examples, each active agent is further configured to generate alerts based on the analysis of the metadata.

In yet another aspect of the present disclosure, there is provided a system configured to execute the aforementioned method.

### DRAWINGS

The drawings included herewith are for illustrating various examples of methods and systems of the present specification and are not intended to limit the scope of what is taught in any way. In the drawings:

FIG. 1 shows a schematic diagram of an implementation of a system in accordance with embodiments of the present disclosure;

FIG. 2 shows a schematic diagram of non-instantiated virtualized security environment in accordance with embodiments of the present disclosure;

FIG. 3 shows an authentication method carried out by a system in accordance with embodiments of the present disclosure;

FIG. 4 shows a schematic diagram of an instantiated virtualized security environment in accordance with embodiments of the present disclosure;

FIG. 5 shows a method carried out by an active agent manager in accordance with embodiments of the present disclosure;

FIG. 6 shows a schematic diagram of an instantiated virtualized security environment in accordance with embodiments of the present disclosure;

FIG. 7 shows an authentication method carried out a system in accordance with embodiments of the present disclosure;

FIG. 8 shows schematic representation of a data structure relating to the user profile in accordance with embodiments of the present disclosure;

FIG. 9 shows schematic representation of a data structure relating to an endpoint in accordance with embodiments of the present disclosure;

FIG. 10 shows a schematic diagram of an implementation of a system in accordance with embodiments of the present disclosure;

FIG. 11 shows a user profile synchronization method carried out by a system in accordance with embodiments of the present disclosure; and

FIG. 12 shows a schematic diagram of an edge device in accordance with embodiments of the present disclosure.

### DESCRIPTION OF VARIOUS EMBODIMENTS

Various embodiments in accordance with the teachings herein will be described below to provide an example of at least one embodiment of the claimed subject matter. No embodiment described herein limits any claimed subject matter. The claimed subject matter is not limited to devices, systems, or methods having all of the features of any one of the devices, systems, or methods described below or to features common to multiple or all of the devices, systems, or methods described herein. It is possible that there may be a device, system, or method described herein that is not an embodiment of any claimed subject matter.

Any subject matter that is described herein that is not claimed in this document may be the subject matter of another protective instrument, for example, a continuing patent application, and the applicants, inventors, or owners do not intend to abandon, disclaim, or dedicate to the public any such subject matter by its disclosure in this document.

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures, and components have not been described in detail so as not to obscure the embodiments described herein. Also, the description is not to be considered as limiting the scope of the embodiments described herein.

It should also be noted that the terms “connected” or “connecting” as used herein can have several different meanings depending in the context in which these terms are used. For example, the terms connected and connecting can have a mechanical or data communication connotation. For example, as used herein, the terms connected and connecting can indicate that two elements or devices can be directly linked to one another or linked to one another through one or more intermediate elements or devices via electrical and/or electromagnetic and/or optical signals, depending on the particular context, so as to be in data communication with other connected devices.

It should also be noted that, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

The example embodiments of the devices, systems, or methods described in accordance with the teachings herein may be implemented as a combination of hardware and software. For example, the embodiments described herein may be implemented, at least in part, by using one or more computer programs, executing on one or more programmable devices comprising at least one processing element and at least one storage element (i.e., at least one volatile memory element and at least one non-volatile memory element). The hardware may comprise input devices including one or more of a touch screen, a keyboard, a mouse, buttons, keys, sliders, and the like, as well as one or more of a display, a printer, and the like depending on the implementation of the hardware.

It should also be noted that there may be some elements that are used to implement at least part of the embodiments described herein that may be implemented via software that is written in a high-level programming language. The program code may be written in Rust, C⁺⁺, C#, JavaScript, Python, or any other suitable programming language and may comprise modules or classes, as is known to those skilled in the art. Alternatively, or in addition thereto, some of these elements implemented via software may be written in assembly language, machine language, or firmware as needed. In either case, the language may be a compiled or interpreted language.

At least some of these software programs may be stored on a computer readable medium such as, but not limited to, a ROM, a magnetic disk, an optical disc, solid-state storage, a USB key, and the like that is readable by a device having a processor, an operating system, and the associated hardware and software that is necessary to implement the functionality of at least one of the embodiments described herein. The software program code, when read by the device, configures the device to operate in a new, specific, and predefined manner (e.g., as a specific-purpose computer) in order to perform at least one of the methods described herein.

At least some of the programs associated with the devices, systems, and methods of the embodiments described herein may be capable of being distributed in a computer program product comprising a computer readable medium that bears computer usable instructions, such as program code, for one or more processing units. The medium may be provided in various forms, including non-transitory forms such as, but not limited to, one or more diskettes, compact disks, tapes, chips, and magnetic and electronic storage. In alternative embodiments, the medium may be transitory in nature such as, but not limited to, wire-line transmissions, satellite transmissions, internet transmissions (e.g., downloads), media, digital and analog signals, and the like. The computer useable instructions may also be in various formats, including compiled and non-compiled code.

As used herein, the term “virtual environment” means any computing environment on a device that allows software to act as through it is alone on that device and has full control of that device. As understood herein, virtual environments include, but are not limited to, virtual machines and containers.

As used herein, the term “virtual machine” means the virtualization or emulation of an entire device (e.g., including the CPU, RAM, and peripherals) and requires the provisioning of an entire operating system (i.e., including the kernel of the operating system).

As used herein, the term “container” means the virtualization or emulation of parts of a device (e.g., in such a way that certain uses of the device are hidden) and non-emulated (but restricted) access to resources present on the host device, such as the kernel of the operating system.

As used herein, the term “endpoint device” means any networked device in which information flows are consumed and/or generated. Endpoint devices include, but are not limited to, user devices such as laptops, smartphones, tablets, and televisions, as well as Internet of Things (IoT) devices, such as refrigerators and smart thermostats. Endpoint devices, as defined herein also include hardware and/or software servers that provide functionality to other endpoint devices.

As used herein, the term “restricted service” means any network-accessible service where the abilities to read, modify, and/or delete information stored by that service, or cause actions to be taken by that service, is dependent on the identification and/or authentication of the user who is seeking to perform that action.

As used herein, the term “edge device” means any device that provides an endpoint device with an entry point to a network. Edge devices include, but are not limited to, network access devices (e.g., routers, gateways and Wi-Fi access points) and user devices (e.g., laptops, smartphones, tablets) having tethering capabilities and/or being capable of acting as wireless access points and routers for devices connected thereto.

As used herein, the term “information flow” means network traffic including, but not limited to, one or more network packets in a packet-switched network.

As used herein, the term “encrypted tunnel” means an encrypted information flow spanning a public or private network.

As used herein, the term “active agent” means a continuously running, autonomous piece of software that performs security functions (e.g., information flow management, access and monitoring) in accordance with security policies.

As used herein, the term “isolated local network” means an isolated network in which packets can travel freely within the network but cannot egress or ingress the network without being subject to security policies carried out by an active agent.

As used herein, the expression “networking parameters” means any measurable factor or setting that defines a data network or sets conditions of its operation.

As used herein, the term “metadata” means any data that provides characteristics about information flows, including summaries and interpretations thereof, including potentially verbatim parts of the information flows.

As used herein, the term “user profile” means a collection of information including the configuration of active agents relating to a use, as well as networking parameters and metadata related to the user. User profiles may also include policies including rules for directing the management of information flows for a user.

As used herein, the term “network destination” means the destination of an information flow sent by an endpoint device in a packet switched network. Network destinations include, but are not limited to, endpoint devices on the same or different isolated networks, unrestricted services, restricted services, etc.

In accordance with the teachings herein, there are provided various embodiments of devices, systems, and methods for providing enhanced, secure networking and connectivity from edge infrastructure.

The devices, systems, and methods disclosed herein are directed to providing enhanced, secure networking and connectivity from edge infrastructure. with proactive continuous risk assessment capabilities. The functionalities are delivered by way of user profiles being flexibly deployed and synchronized “at the network edge”. User profiles in accordance with the present disclosure can be deployed to multiple edge locations, and every deployment provides full user device isolation.

Active agents being instantiated using user profiles in accordance with the present disclosure can be virtualized and designed to run on a wide range of edge infrastructure that meet performance and security standards. As such, the devices, systems and methods of the present disclosure offer significant security and performance advantages over known endpoint-based solutions and provide significant flexibility and cost advantages over vendor-specific solutions.

The devices, systems, and methods disclosed herein also provide continuous risk assessment, with an emphasis on detecting risks proactively, as opposed to waiting for adverse events to be detected. Furthermore, the devices, systems, and methods disclosed herein provide enhanced Secure Access Service Edge (SASE) functionalities with full isolation for all user devices across a range of access point types, SASE functionalities to remote workers on multiple edge hardware types, and continuous risk assessment, enabling a proactive approach to managing cyber risk, as well as comparatively high levels of user privacy.

The edge infrastructure provided by the devices, systems, and methods disclosed herein provides multiple capabilities that are currently poorly delivered via the cloud or via user endpoint devices. By being directly in the stream of data, the edge infrastructure provided by the devices, systems, and methods disclosed herein can authenticate, encrypt, route, monitor, and filter flows of information in sophisticated ways. In prior art systems, these authentication, security, and routing functions are predominately performed on user endpoints, and in infrastructure located in the cloud, as opposed to the edge (e.g., VPNs). Such prior art systems therefore particularly subject to security vulnerabilities, including those resulting from lack of user isolation, lack of unified user risk models, compromised performance, complexity and cost of endpoint device management, lack of support for increasingly diverse types of endpoints, and compromise of user privacy.

The devices, systems, and methods disclosed herein solve these problems by providing a novel user profile that is deployed to a novel edge infrastructure. While most prior art systems manage users' online connectivity and security on every endpoint device, the devices, systems, and methods disclosed herein manage users' online connectivity and security via a user profile which includes networking parameters and metadata such as, but not limited to, user authorization credentials, including biometrics, a list of approved user devices authorized on the profile, specific network settings pertaining to approved devices, Domain Name System (DNS) filtering settings, Intrusion Detection System (IDS) and Intrusion Prevention System (IPS) settings, user notification preferences, network traffic routing information, network traffic blocking and authorization settings, baseline traffic definition on a per-profile basis, baseline traffic definition on a per-authorized device basis, anomaly history versus all baselines, and quantitative risk indicators derived from a range of factors, including detected anomalies and past IDS/IPS events. As will be appreciated by the skilled reader, baseline traffic relates to patterns of information flows having specific characteristics (e.g., source, destination, type of data, time of day, etc.).

As such, the user profiles created, used, updated and synchronized by the devices, systems, and methods disclosed herein do not need to exist on endpoint devices, and are not permanently attached to edge infrastructure. Instead, these user profiles exist and are managed securely in the cloud, and deployed, semi-permanently or on-demand temporarily, to edge infrastructure using virtualization or other suitable means, as described in more detail elsewhere herein.

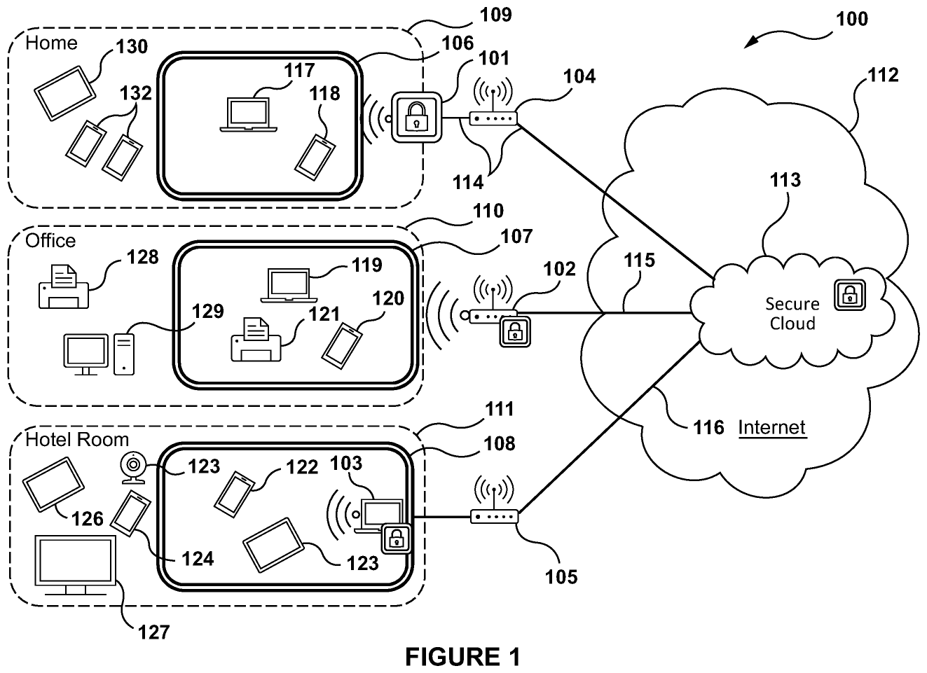

FIG. 1 shows a schematic diagram of an implementation of a system 100 in accordance with embodiments of the present disclosure. In this example, system 100 includes edge devices, 101, 102, 103 and secure cloud infrastructure 113, which is connected to edge device 101, 102 and 103 via the internet, as disclosed in more detail elsewhere herein. The secure cloud infrastructure is part of the system of the present disclosure and acts as a secure service for managing user profiles and identification and authentication of users and devices. As will be appreciated by the skilled reader, the secure cloud infrastructure can be formed of functionally and/or structurally distributed computing resources forming a cloud-based secure computing environment.

The system further includes Wi-Fi networks 109, 110, 111, which may be created at different physical locations, such as a user's home, office and hotel room. For example, network 109 may be created by router 104 at a user's home, network 110 may be created by router 102 at a user's office and network 111 may be created by router 105 in a hotel room. Network 109 created by router 104 may have endpoint devices 117, 118, 130 and 132 connected thereto via, for example, a wireless communication protocol such as IEEE 802.11. Similarly, network 110 created by router 102 may have endpoint devices 128, 129, 119, 120 and 121 connected thereto and network 111 created by router 105 may have endpoint devices 103, 126, 125, 124, 127, 122 and 123 connected thereto.

As will be appreciated by the skilled reader, the endpoint devices connected to wireless networks 109, 110, 111 may include any suitable endpoint device, including, but not limited to smartphones (such as 132, 118, 120, 122, 124), tablets (such as 130, 123, 126), laptop computers (such as 117, 119, 103), televisions (such as 127), desktop computers (such as 129), printers (such as 121 and 128), and video cameras and/or any other Internet of Things (IoT) device (such as 125).

The system 100 also includes edge devices 101, 102, 103, configured to establish isolated networks 106, 107, 108, respectively. Isolated networks 106, 107, 108 are created in accordance with security policies forming part of the user profile of the user, as described in more detail elsewhere herein. Edge device 101 may be a dedicated piece of hardware that is connected in a wired or wireless way to router 104. Non-limiting examples of edge device 101 include a wireless access points and wireless routers. Edge device 102 may be a wireless router 102, which may be provided by an Internet Service Provider (ISP). In some embodiments, edge device 103 may be a laptop with the capability to create a wireless Wi-Fi network.

The skilled reader will appreciate that edge devices in accordance with the present disclosure need not be of a particular type or manufacturer, provided that they have the software functionality described herein.

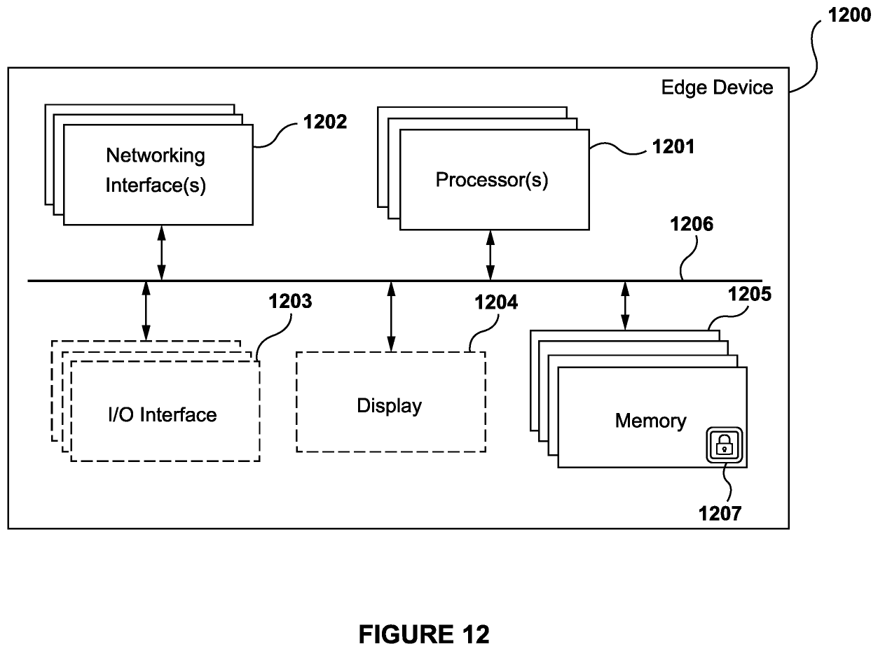

An example edge device 1200 in accordance with the present disclosure is shown in FIG. 12. In some embodiments, the edge device 1200 includes a router or Wi-Fi access point running an application with storage, communication, and processing means. However, it is contemplated that in other embodiments, other computer systems may be used as an edge device. For example, in some embodiments, the edge device may include a desktop computer, a tablet computer, a laptop, or similar, or in other embodiments, a smart phone running an operating system such as, for example, Android®, iOS®, Windows® mobile, or similar.

In some embodiments, the edge device 1200 may comprise one or more processors 1201, one or more networking interfaces 1202, and memory 1205. In some embodiments, the edge device 1200 may also comprise one or more Input/Output (I/O) interface(s) 1203 and a display 1204. The term “processor” as used herein refers to any quantity and combination of a processor and may be provided through the use of dedicated hardware as well as hardware capable of executing software in association with appropriate software. When provided by a processor, the functionality described herein may be provided by a single dedicated processor, by a single shared processor, or by a plurality of individual processors, some of which may be shared. Other hardware, conventional and/or custom, may also be included.

In some embodiments, one or more processors 1201, one or more memories 1207 and one or more networking interfaces 1202 are configured for bidirectional data communication through the internal network 1206 of the edge device 1200, and accordingly can include network adaptors and drivers suitable for the type of network used. One or more memories 1205 may include volatile storage and non-volatile storage for storing program code executed by one or more processors 1201 and/or data used during operation of one or more processors 1201. A memory of one or more memories 1205 may be a semiconductor medium (including, for example, a solid-state memory), a magnetic storage medium, an optical storage medium, and/or any other suitable type of memory. In some embodiments, one or more memories 1205 include a virtualized security environment 1207, as described in more detail elsewhere herein.

In the example shown in FIG. 1, edge devices 101, 102, 103 are configured to connect to a subset of the devices included in networks 109, 110, 111. In particular, edge device 101 is configured to establish an isolated network 106 including endpoint devices 117 and 118, exclusively, edge device 102 is configured to establish an isolated network 107 including endpoint device 119, 120 and 121, exclusively, and edge device 103 is configured to establish an isolated network 108 including edge device 103 and endpoint devices 122 and 123, exclusively.

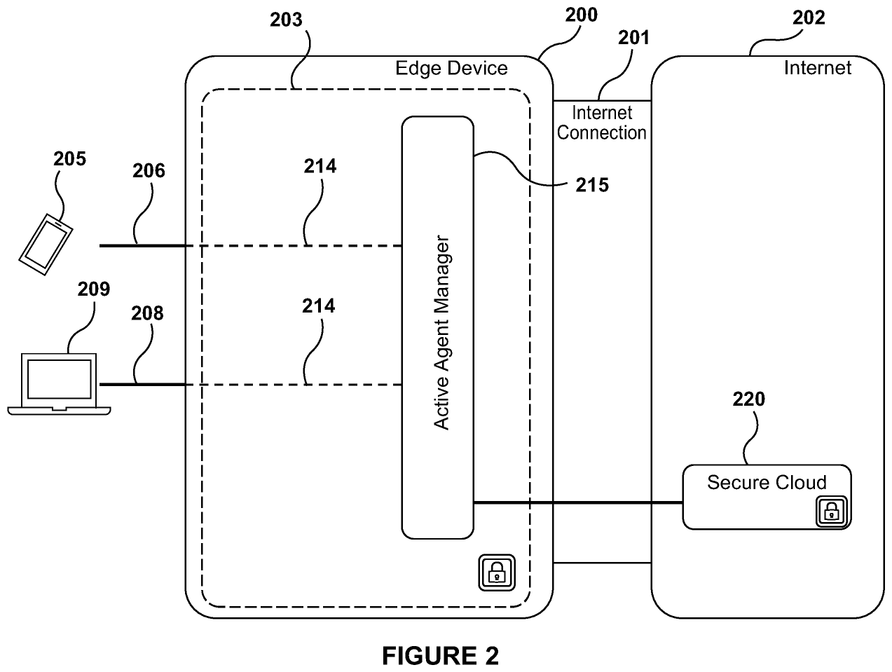

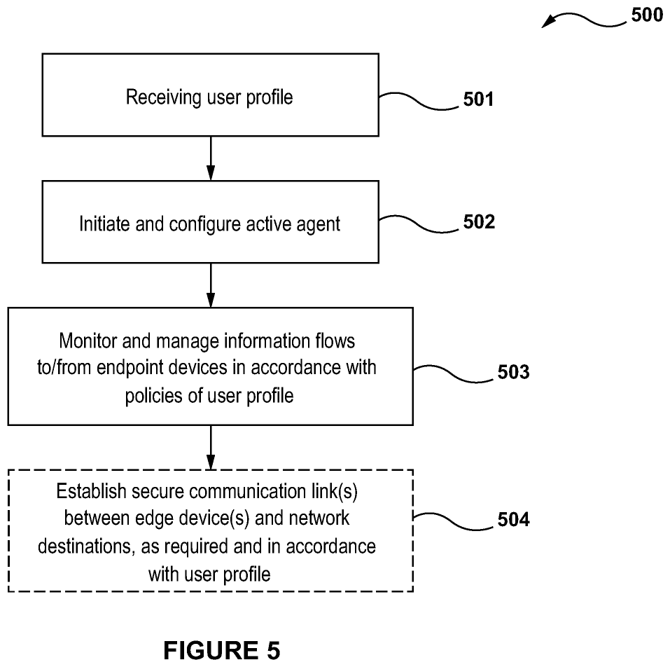

In the embodiment shown in FIG. 1, each isolated network 106, 107, 108 is established using the same user profile, and in accordance with the method described with reference to FIG. 2 to FIG. 5.

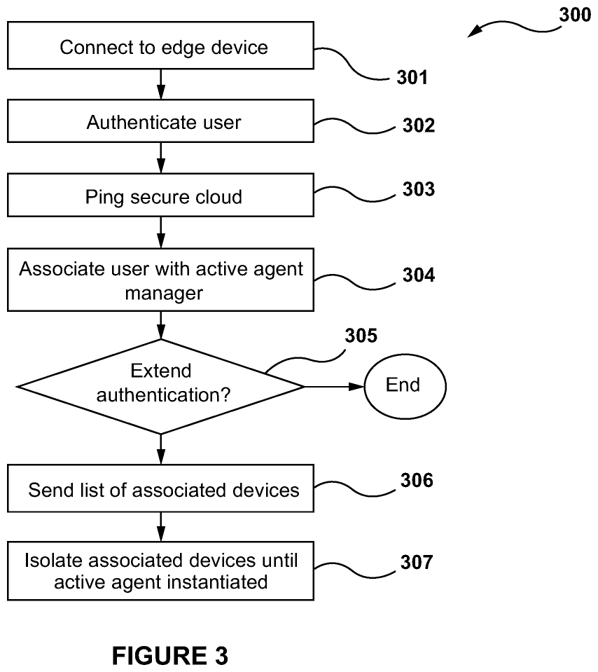

FIG. 2 shows a schematic diagram of non-instantiated virtualized security environment 203 of an edge device 200 in accordance with embodiments of the present disclosure. FIG. 3 shows an authentication method carried out by a system in accordance with embodiments of the present disclosure.

Edge device 200 can be connected to the internet 202 by way of an internet connection 201 using known methods. An active agent manager 215 is loaded on to edge device 200 as a piece of software. Loading the active agent manager 215 onto the edge device may be performed using any number of known methods. For example, the active agent manager 215 may be loaded onto the edge device 200 as part of a factory install, or it may subsequently be downloaded from an app store platform. In some embodiments, the active agent manager 215 may be configured to be rendered inoperable if downloaded onto an edge device running an out-of-date operating system (OS), and/or an OS that is otherwise deemed to be unsecure. In some embodiments, the active agent manager 215 may be configured to only run on a cryptographically signed OS.

Active agent manager is configured to establish an encrypted connection 216 to secure cloud 220. As will be appreciated by the skilled reader, an encrypted connection can include, but is not limited to, access to a remote (e.g. office) LAN. Such access may be established via, for example, IPSec, OpenVPN, etc., or other known protocols. Other examples of encrypted connections include, but are not limited to, a WireGuard™ tunnel, a cloud access security broker (CASB) connection, and a connection secured using secure file transfer protocol (FTPS). Active agent manager 215 may establish an encrypted Wi-Fi connection 206 with smartphone 205 and may connect to endpoint device 209 by way of secured ethernet connection 208. Active agent manager 215 may be connected to external secured connections 206, 208 by way of internal socket connections 214.

Active agent manager 215 is configured to detect connection requests from endpoint devices 205 and 209. Once a request is received, the active agent connects to an endpoint device at step 301. Whether the active agent manager 215 connects to an endpoint device or not will depend on whether the active agent manager 215 recognizes the identity of the endpoint device. In some embodiments, the active agent manager 215 may hold records of endpoint device identities for all endpoint devices with which connections have previously been established. In some embodiments, active agent managers 215 may hold records of endpoint device identities for all endpoint devices that have previously been authenticated using methods described herein. In some embodiments active agent managers 215 may be pre-configured to recognize a certain number of endpoint device identities. In some embodiments, active agent managers 215 may receive records of endpoint device identities for all endpoint devices listed in a user's profile from a secure cloud as a result of an authentication of the active agent manager 215, as described elsewhere herein.

In each of the above examples, endpoint device identification can be achieved using any number of known methods. For example, in some embodiments, active agent manager may use the Media Access Control (MAC) address of endpoint device as an identity.

The active agent manager 215 may monitor all traffic being sent from devices with which it is connected, as well as all traffic destined to devices with which it is connected. In some embodiments, the active agent manager 215 monitors all traffic transiting through edge device 200. In some embodiments, monitoring of traffic includes the use of an extended Berkley packet filer (eBPF). In some embodiments, monitoring of traffic includes data processing techniques such as deep packet inspection (DPI).

Before an active agent can be instantiated in the virtualized security environment 203 of an edge device 200, as described elsewhere herein, the active agent manager 215 must be authenticated. One of the features of the devices, systems, and methods disclosed herein is that they are configured to implement a nexus of trust which allows authentication to be “extended” from an initial device to subsequent devices. In some embodiments, this can be achieved by way of an application (or “app”) running on, for example, a mobile communication device such as a smart phone. The installed app (not the mobile communication device) can communicate securely to secure cloud 220 and may act as the starting point of the nexus. As such, other devices in the system, including edge device 200, smartphone 205 and laptop 209 are passive receivers of identification and authentication, and are subjected to traffic monitoring and traffic shaping.

FIG. 3 shows an authentication method 300 carried out by a system in accordance with embodiments of the present disclosure. At step 301, a user enters may enter within Wi-Fi range of edge device 200 at, for example, the user's home. At step 301, smartphone 205 connects to edge device 200. At step 303, the app may use smartphone 205 to authenticate the user using any known technique such as, but not limited to, facial recognition, fingerprint recognition, etc.

Once the user is authenticated by the app, at step 303, the app running on smartphone 205 pings the secure cloud 220, which ping contains a token which uniquely identifies the user. Because the token originates from the same IP address as the active agent manager 215 on edge device 200, the secure cloud 220 associates the token (and therefore the user) with the active agent manager 215 at step 304. The user is now associated with the active agent manager 215 of edge device 220.

At step 305, the secure cloud 220 then communicates with the app on smartphone 205 to ask the user whether they wish to extend their authentication to the active agent manager 215. This can be done using any known technique using the graphical user interface of smartphone 205. The user may thus decide to extend the nexus of trust from the app to the active agent manager 215 residing on edge device 200. In other words, the user may decide to allow the active agent manager 215 residing on the edge device to receive and use their user profile to instantiate an active agent, as described in more detail elsewhere herein.

If the user decides not to extend the nexus of trust from the app to the active agent manager 215 residing on edge device 200, then a secure cloud is notified accordingly and the active agent manager is not authenticate by secure cloud 220.

If, on the other hand, the user chooses to extend the nexus of trust to the active agent manager 215 at step 305, secure cloud 220 prepares and sends to the active agent manager 215 a list of endpoint device identities associated with the user at step 306. In some embodiments, the list of endpoint device identities associated with the user is retrieved from the user's user profile. In the example shown in FIG. 2, smartphone 205 may be include in the list of devices associated with the user profile, while laptop 209 may not.

As will be appreciated by the skilled reader, other means of authenticating a user, and therefore establishing a nexus of trust, may be implemented. For example, the physical possession of a registered edge or endpoint device, the use of public/private key mechanisms, the possession of a physical token, the use of secrets such as SSID passwords, authentication via a web service, or other known methods may be used. In addition, different user profiles may require different levels of trust to be established, which may inform which mechanisms are available to establish sufficient trust for that profile.

At step 307, the active agent manager 215 isolates all device associated with the user profile until such time as an active agent associated with the user profile is instantiated, as described in more detail elsewhere herein. As such, smartphone 205 will not have the ability to send or receive traffic flows through edge device 200 until such time as the user's user profile has been received by active agent manager 215 and an active agent has been instantiated in accordance with user profile.

Once the user has been authenticated by the system, and the user's authentication has been extended to the active agent manager 215 (and edge device 200), as described elsewhere herein, the active agent manager 215 can instantiate an active agent in accordance with the following method.

The user profile contains a plurality of networking parameters and metadata associated with the one or more endpoint devices 205 and one or more network destinations, such as restricted service 218. Exemplary embodiments of data structures relating to user profiles are described in in more detail elsewhere herein.

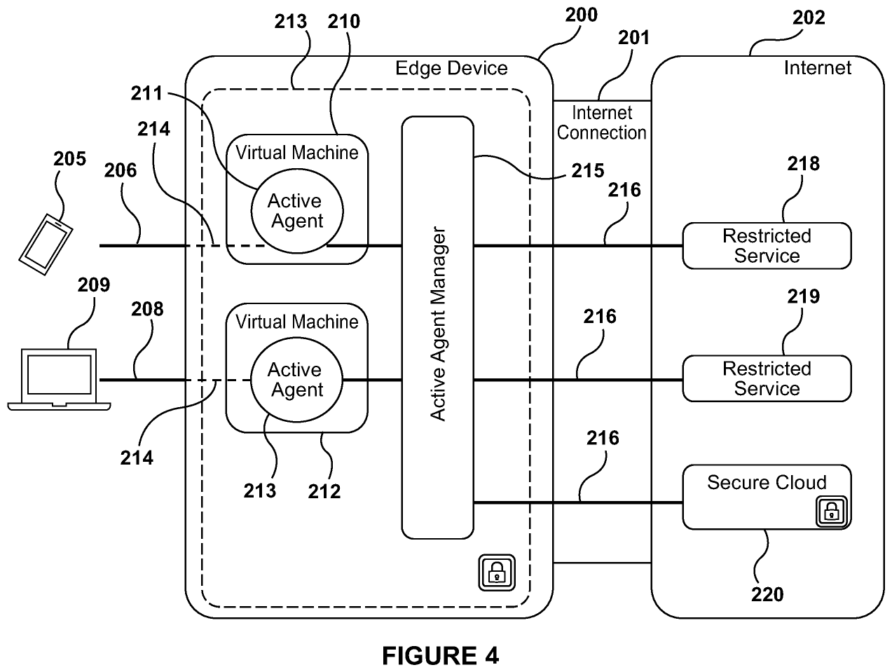

At step 501, active agent manager 215 receives the user profile and associates it with the user of endpoint device 205. Then, at step 502, active agent manager creates an active agent 211 to monitor and manage information flows to and from all endpoint devices associated with the user profile and other network destinations (such as restricted service 218). It does this by instantiating and configuring an active agent using information associated with the user profile to monitor and manage communications between endpoint device 205 and network destinations using information associated with the user profile, as described in more detail elsewhere herein. In some embodiments, active agent 210 may be instantiated as part of a virtual machine 211, as shown in FIG. 4, or, alternatively, as part of a virtual container, or, alternatively, directly on the edge device.

As will be appreciated by a skilled reader, a user profile may represent a role, as opposed to a person, with that role being to manage the network state of one or more, and possibly a large number, of endpoint devices. One example of such is large number of IoT (Internet of Things) devices, spread across multiple physical locations, with the goal of providing a uniform networking environment to each of the devices, with the ability to update that environment in a parallel, synchronized manner.

As will be appreciated, active agent manager 215 may use the above method to instantiate and configure any number of active agents on edge device 200 (for example active agent 213 forming part of virtual machine 212), with each active agent 211, 213 being associated with a different user and having been instantiated and configured using the user's user profile.

In some embodiments, the active agent manager 215 in accordance with the present disclosure may further be configured to send the virtual machine and/or container within which is implemented an active agent from a first edge device to a second edge device. This embodiment would be particularly useful when travelling within a large physical location covered by multiple edge devices. In a situation in which an endpoint device travels from a zone covered by a first edge device and a zone covered by a second edge device, the container or virtual machine containing the active agent in the first edge device may be “frozen”, transmitted to the second edge device and then “unfrozen”. In such a case, any active encryption tunnels that have been established using the first edge device are preserved and simply transferred to the second edge device, thereby avoiding any problems associated with the endpoint device having to reconnect to a new edge device.

Once instantiated and configured, at step 503, active agents 211, 213 may monitor and manage information flows to and from endpoint devices 205, 209 in accordance with the policies set out in the user profiles that were used to instantiate and configure them, as described in more detail elsewhere herein. In some embodiments, active agent manager 215 will continue to monitor information flows to and from endpoint devices 205, 209 but will no longer manage information flows to and from endpoint devices 205, 209.

Once instantiated and configured, at step 504, active agents 211, 213 may also establish and remove secure communication links 216 with various network destinations, as required by endpoint devices 205, 209, and in accordance with policies set out in a user's user profile. For example, a secure communication link (such as an encrypted tunnel/connection) may be established between edge device 200 and a network destination. In the example shown in FIG. 4, a first encrypted connection 216 is established between active agent 211 and restricted service 218. As will be appreciated by the skilled reader, an encrypted connection can include, but is not limited to, access to a remote (e.g. office) LAN. Such access may be established via, for example, IPSec, OpenVPN, etc., or other known protocols. Other examples of encrypted connections include, but are not limited to, a WireGuard™ tunnel, a cloud access security broker (CASB) connection, and a connection secured using secure file transfer protocol (FTPS).

In some embodiments of the present disclosure, as referenced as 218 or 219 in FIG. 4, a restricted service may be another edge device configured in a similar way to edge device 200. In such embodiments, a secure connection between endpoints in two separate physical locations can be established, with the two intermediating edge devices arranging and managing information flows between the two endpoints.

In some embodiments, an example of which is shown in FIG. 4, a single active agent manager 215 running on a single edge device 200 may instantiate multiple active agents 211, 213. As will be appreciated by the skilled reader, each active agent 211, 213 may be established using a different user profile associated with the different user, and may connect to different endpoint devices 205, 209 using different means, as required. For example, active agent 213 may connect to endpoint device 209 by way of secured ethernet connection 208. Moreover, a single user may have multiple user profiles (e.g., one associated with work, another associated with personal use). In such scenarios, a single user may require the instantiation of multiple active agents (i.e., one for each user profile).

Disinstantiating of the active agent may be performed by the active agent manager when none of the endpoint devices associated with the user profile have been connected to the edge device for a predetermined amount of time.

As will be appreciated, one of the significant advantages of implementing active agents 211, 213 as part of virtual machines or in containers is ease with which it is possible to instantiate and disinstantiate active agents 211, 213. Significant portions of the state associated with network configuration and the creation of secure connections to various destinations is contained within the edge device kernel, and any errors in managing that state represents a potential security flaw. Therefore, the use of either virtual machines or containers—both of which provide the functionality to reset that state to a known default configuration between instantiations—enhances the security of the system, as well as reduces errors unrelated to security.

Some embodiments of the present disclosure may not rely on the configuration of edge device kernel state, and therefore may be securely implemented without the use of virtual machines or containers. As will be appreciated, in such embodiments, the roles of an active agent manager and/or the one or more active agents may be performed by fewer, or perhaps a single, instantiation of software.

In some embodiments, the roles of the active agent manager and one or more active agents are implemented as a combined instantiation, within or outside the confines of a virtual machine or container on the edge device.

Active agents 211, 213 are configured to monitor and manage information flows to and from one or more endpoint devices 205, 209. In some embodiments, examples of managing and monitoring information flows to and from one or more endpoint devices 205, 209 include, but are not limited to, the following capabilities.

In some embodiments, active agents 211, 213 are configured to generate and collect metadata about information flows and endpoint devices. In some embodiments, such metadata may include the timing and volume of information flows, their sources and destinations, the types of resources being accessed (e.g., a web site or a video chat), and the organization(s) responsible for the resource(s) being accessed via that information flow.

In some embodiments, active agents 211, 213 are configured to record metadata, both locally and at a centralized location. For example, active agents 211, 213 may be configured to record and store metadata locally and send metadata to secure cloud 220 for further processing.

In some embodiments, active agents 211, 213 are configured to establish behavioral baselines (also known as baseline traffic) for endpoint devices based on stored metadata, where the usual behavior of users and endpoint devices can be compared to subsequent behaviors to detect compromised endpoint devices, compromised identities, or malicious actions. A non-limiting example of this is a situation in which a corporation may provide employees with access to a suite of software as a service (SaaS) business tools from a first supplier and an employee of the corporation starts using business tools form a second supplier. In such a situation, the baseline traffic may be characterized as being between an employee's device(s) and the servers of the first supplier, and a deviation from such baseline traffic may be when information flows are directed towards servers of the second supplier. Another non-limiting example of this is a situation in which baseline traffic to a networked printer is characterized by documents being sent to the printer from various locations, and a deviation from such baseline traffic may be when the printer begins sending out packets to the internet, which deviation could be an indication that the printer has been compromised and is now part of a botnet. As will be appreciated by the skilled reader, in each example, the baseline and deviation can be recognized without knowing anything specific about what is going on, just that an established pattern of usage has changed.

In some embodiments, active agents 211, 213 are configured to route, encrypt, filter, and attenuate the bandwidth of information flows based on analysis of the stored metadata, and/or based on user profile configuration, for the purposes of enhancing or optimizing security and/or Quality of Service (QoS). In some embodiments, such analysis may be performed locally (e.g., by the active agent 211, 213 on edge device 200) or remotely by secure cloud 220. In some embodiments, such analysis can be performed by a combination of local and remote analysis, in which some analysis is performed locally on edge device 200 and some remotely on the secure cloud 220, for example. In some embodiments, a subset of a user profile may be modified by a third-party provider of a service in such a way that the information flow from an endpoint device to that service is influenced by the provider.

In some embodiments, a third-party provider of a service may be allowed to modify the subset of a user profile which concerns their service. In this way the service may perform security and/or QoS enhancements which may be difficult or impossible without access to the information flow to their service before or after it traverses the internet.

In some embodiments, active agents 211, 213 are configured to generate alerts to be sent to the users associated with the user profiles used to instantiate and configure active agents 211, 213. Such alerts may be sent to the users themselves and/or to one or more contacts at the organization whose restricted services are being accessed.

In some embodiments, active agents 211, 213 are configured to provide “identity at the edge” functionality including, but not limited to, login into websites and/or webservices that are known and can interact with the secure cloud. For example, a user may wish to log into a website hosted on a web server. When the user opens their laptop and directs their browser to the website, the web server can acquire the IP address of the requesting laptop via the edge device, which may be doing Network Address Translation (NAT). The web server may, in cooperation with the secure cloud, match the IP address of the laptop to an IP address of one of active agents 211, 213. The web site may then ask active agents 211, 213 if either of them detected the website request. If, for example, active agent 211 confirms that it detected the website request, the authentication of active agent 211 is then further “extended” to the web site request. The web server may then return a cookie containing a standard “logged in” token for that particular user.

In some embodiments, some or all of the information flows sent to a restricted service may be encapsulated, annotated, or reported via a separate trusted channel to establish the identity or nature of the origin of that information flow to third parties.

For example, in addition to the method described above, further implementations may convey identity information by encapsulation of the network packets or alteration of their contents in a way that the webservice recognizes as conveying or supplementing identifying information. Yet other implementations may observe unique characteristics of the network packets and convey this information to the webservice via a separate, trusted, channel, which may then be matched on the receipt of the observed packets at the webservice, thereby fulfilling a similar function as annotation and/or encapsulation.

As such, by providing “identity at the edge” functionality, active agents can extend a user's authentication (which was extended to it using method described in more detail elsewhere herein) to a website request, and thereby seamlessly and transparently login to websites and webservices without the need for user/password login procedures.

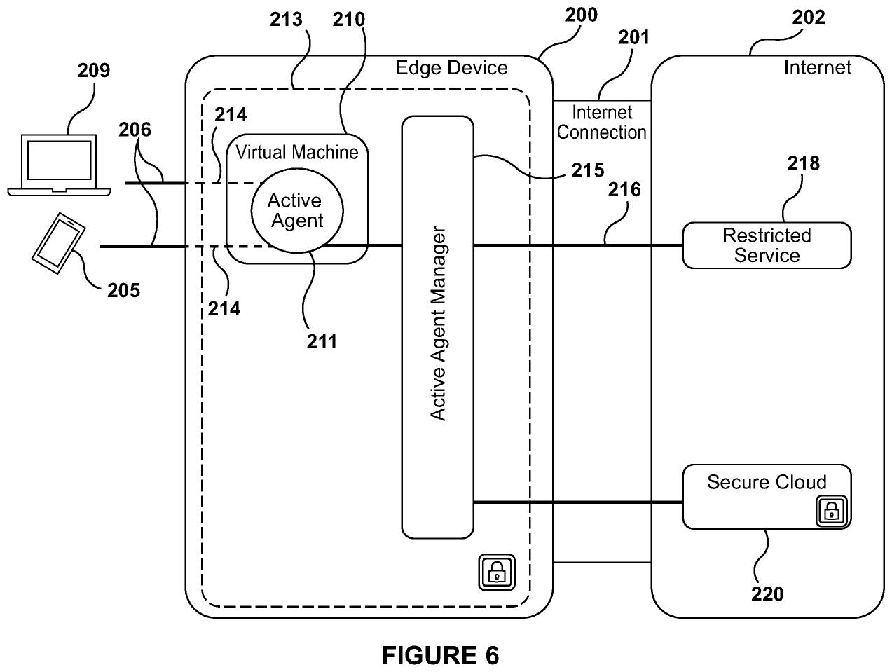

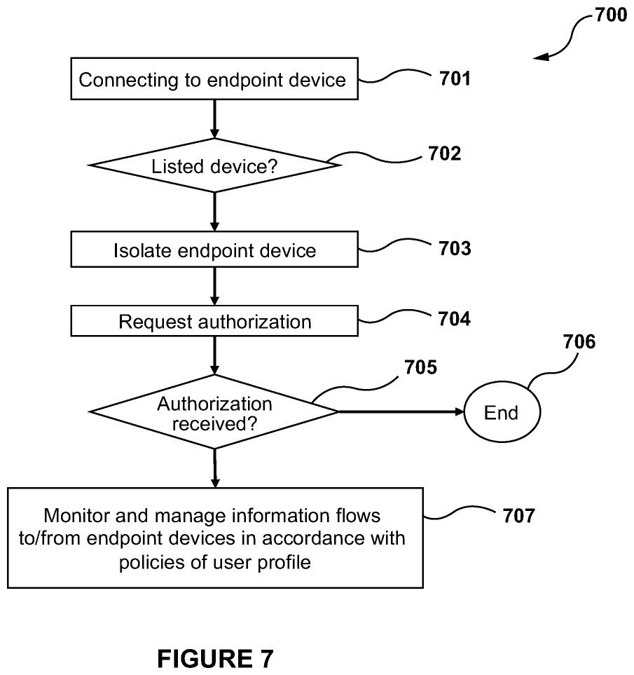

With reference to FIGS. 6 and 7, a method for authorizing an endpoint device will now be described. At step 701, a user opens their laptop 204 and a connection is established between the laptop and the edge device 200. Because the laptop is listed in the user profile that was used to instantiate and configure active agent 211, active agent 211 will recognize laptop 204 at step 702 as a device listed in the user profile associated with the user. At that point, and until the laptop 204 is authorized by the user, active agent 211 will isolate laptop 204 as described elsewhere herein. As such, laptop 204 will not have the ability to send or receive traffic flows through edge device 200 until such time as the user has authorized laptop 204. Then, at step 704, active agent 211 sends an authorization request to secure cloud 220, which in turn sends an authorization request to the app running on smartphone 205. The app notifies the user that the laptop requires authorization and allows the user to authorize the laptop. Then, at step 705, if authorized by the user, the response is sent to the secure cloud, which in turn sends the authorization to the active agent 211. If no authorization is received by the system from the user, then the system may wait for an authorization to be received or simply not authorize laptop 204. If, on the other hand, an authorization is received, then the active agent 211 is notified by the secure cloud 220 and the laptop is authenticated. Once authenticated, at step 707, active agent 211 monitors and manages information flows between laptop 204 and network destinations using information contained in the user profile. As such, authentication can be “extended” from the user to a new endpoint device.

In other embodiments, authorization of endpoint devices may be performed using known or novel methods, such as public/private key authentication, simple matches of identifiers such as MAC addresses, or methods which infer identity from a combination of identity-suggesting characteristics. Such methods may augment or replace interaction with a user to establish endpoint device authorization.

Active agent 211 may implement a risk assessment engine. The risk assessment engine may be custom-built system to sense, collect, analyze, score, and aggregate risk assessment indicators.

Secure cloud 220 may implement a portal. The portal may provide an end-user view of connection status through a web browser or a mobile app. The portal may also provide a corporate administrator view to review connection status and risk ratings across all their users. The portal may enable some self-serve functionalities as well, including changing Wi-Fi password, adding new devices, etc.

As described in more detail elsewhere herein, active agent 211 may require authentication of all devices joining the secure network. The authentication process may request a biometric authentication, two-factor or multi-factor authentication, and the like, via the secure cloud 220 and an app running on, for example, a smartphone 205. Other types of authentication may be implemented without diverting from the scope of the disclosure. The system disclosed herein may require ongoing user identity monitoring to ensure “perpetual” authentication.

Active agent 211 may perform ongoing continuous risk monitoring to proactively address cyber risks before they become imminent. For example, a scan may be initiated by active agent 211 to be performed on one or more devices connected to the edge device 200. The scan may determine vulnerabilities of the device (e.g., old software versions that have not been updated or patched, unsecure network segments that do not require authentication, etc.). Additional software may be embedded on the connected devices to perform these scans. In some embodiments, active agent 211 is configured to create risk management profiles for each of the one or more endpoint devices based on the metadata, which risk management profiles can then be used to enact policies associated with the user profile.

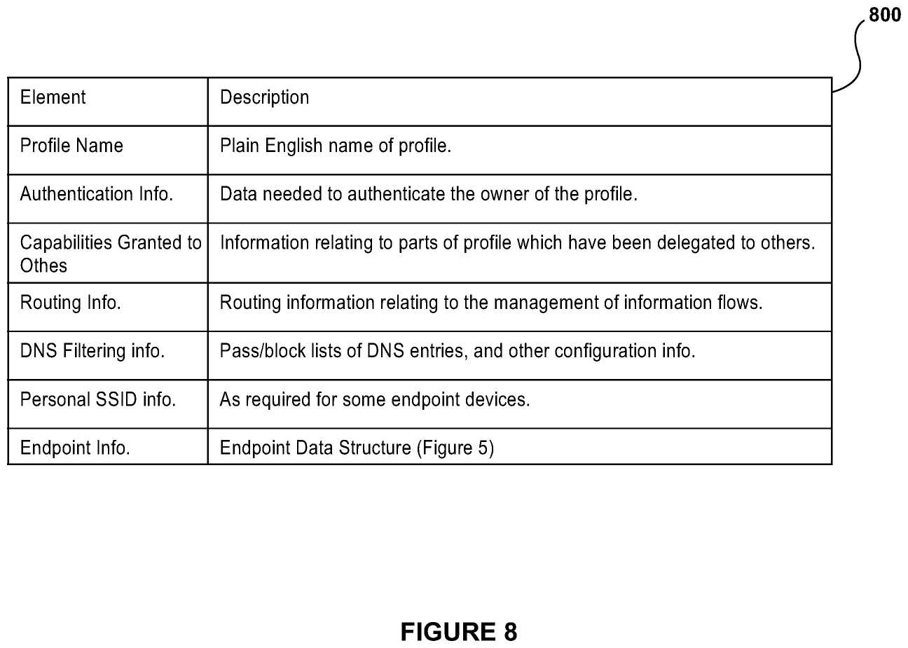

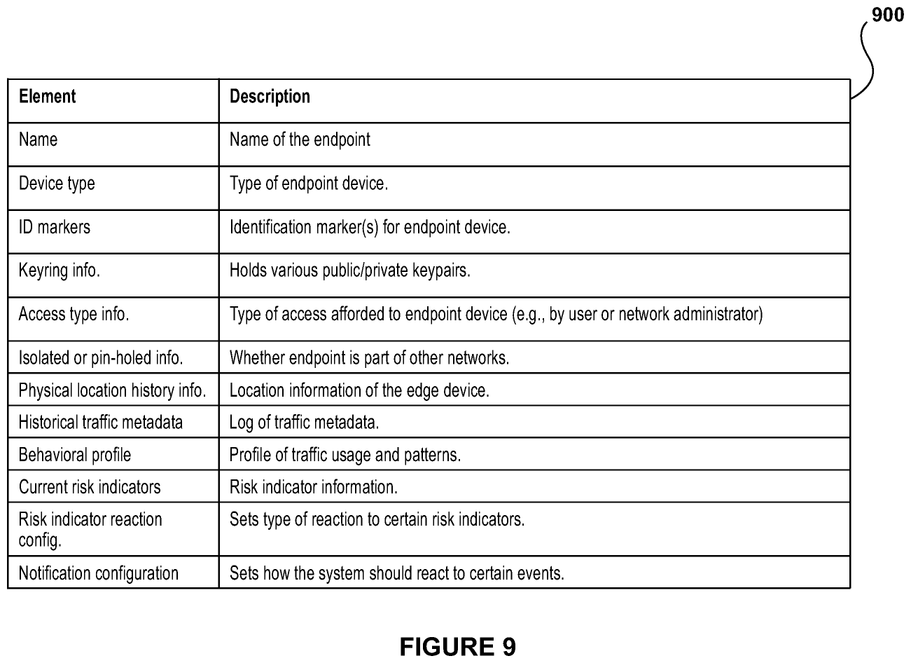

As will be appreciated by the skilled reader, instantiation of an active agent in accordance with the methods disclosed herein may include creation and configuration aspects. Moreover, as will be described in more detail elsewhere herein, once an active agent is instantiated by an active agent manager, the configuration of the active agent is synchronized with the most current state of the user profile. Some embodiments of a user profile, as well as associated configurations of an active agent will now be described with reference to FIGS. 8 and 9.

FIG. 8 shows a schematic representation of a data structure 800 relating to the user profile in accordance with embodiments of the present disclosure. In some embodiments, the data structure of a user profile includes the following elements.

Profile name is a “plan English” name of the profile. It allows users, for example, to select it from a list during authentication and/or configuration. This information is not used by the active agent.

Authentication information relates to the data needed to authenticate the owner of the profile. Such information may include, but is not limited to, usernames/passwords, biometrics, One-Time Passwords (OTPs), account recovery information. In some embodiments, this may be used by a user to log into their account (provided by secure cloud 220). This information is not used by the active agent.

Capabilities granted to others comprises information relating to parts of a user profile that may be delegated to others. Examples of such capabilities include, but are not limited to, any aspect of the user profile that may have been delegated to a network administrator, or the automatic enforcement of company-wide security policies. Such information is not used by the active agent.

Routing information includes information relating to the management of information flows. In some embodiments, such information defines which endpoint devices are permitted to see each other on the isolated local network, how endpoint devices are permitted to communicate with each other and/or restricted services (e.g., restrictions on ports, protocols, and service types), and when endpoint devices are permitted to communicate with each other and/or endpoint devices (i.e., automatic time-gating). In some embodiments, routing information may include information necessary to perform QoS attenuation of traffic, and special case rules (e.g., ensuring that email communications are always sent through an encrypted tunnel). In some embodiments, routing information may be implemented in the active agent as iptables entries (i.e., kernel packet routing tables) and/or encrypted tunnels (e.g., using WireGuard™), depending on the route taken.

DNS filtering information includes pass/block lists of DNS entries, and other DNS configuration information. In some embodiments, this is implemented on the active agent by examining DNS packets from all endpoint devices and discarding some accordingly.

Personal Service Set Identifier (SSID) information may be required when one or more endpoint devices require a personal SSID.

Some devices might need a personal SSID. In some embodiments, the active agent manager may set up the required SSIDs on the edge device.

Endpoint information relates to per-endpoint data and may form part of user profile data structure. FIG. 9 shows a schematic representation of a data structure 900 relating to an endpoint in accordance with embodiments of the present disclosure. In some embodiments, the data structure relating to an endpoint includes the following elements.

Name of the endpoint may include a simple, plain English name allowing a user to identity an endpoint (e.g., “work laptop”). This information is not used by the active agent.

Identification markers for endpoint devices includes information allowing an active agent (or an active agent manager) to identify the endpoint device on reconnection to the edge device (e.g., MAC address, a pointer to a public/private keypair in a keyring). This information can be used by the secure cloud and/or the active agent manager to identify and/or authenticate an endpoint device.

Keyring information holds various public/private keypairs. In some embodiments, keyring information may be used by the secure cloud and/or the active agent manager to identify and/or authenticate an endpoint device, as well as establish encrypted tunnels.

Access type information relates to the type or level of access that the system affords an endpoint device (e.g., by user or network administrator). When an endpoint device connects to the isolated local network, it must be permitted by the user (via the secure cloud, for example). This information may determine how long that permission lasts, and whether on reconnect the endpoint device needs to be re-permitted (e.g., on a daily basis). In some embodiments, this information may be used by the active agent manager when deciding whether to allow a device to connect and/or stay connected to the isolated local network.

Isolated or pin-holed information related to whether the endpoint device also forms part of the surrounding untrusted network or is exclusively connected to the isolated local network. In the former case, the active agent may use, for example, iptables to create a “pinhole” in the isolated local network to allow for very restricted communications with this device, which is located outside the isolated local network.

Physical location history information related to the location of the endpoint device (i.e., to what edge device it is connected to) and, optionally, the geolocation of the endpoint device's external IP address. In some embodiments, this information may be timestamped. In some embodiments, this information may be used by the secure cloud for endpoint device identification and/or authentication (e.g., the same device connecting in two places at once is suspicious). In some embodiments, this information may also be used for constructing encrypted tunnels between two different endpoint devices in different isolated local networks.

Historical traffic metadata comprises a time-series log of all the raw traffic metadata to/from this endpoint device. In some embodiments, this metadata is collected by the active agent and then streamed up to the secure cloud.

Behavioral profile information relates to the type and quantity of traffic being sent and received from the endpoint device, as well as other traffic pattern characteristics (e.g., what times of day and days of the week). In some embodiments, this profile is constructed from the historical traffic metadata, and used to establish a baseline of expected network usage that can be used to calculate risk indicators. This information may primarily be used by the secure cloud.

Current risk indicator information is generated by applying risk assessments to the current and past behaviors of the endpoint device, as defined by the behavioral profile information. This information may primarily be used by the secure cloud.

Risk indicator reaction configuration enables the secure to decide how to react to a new risk indicator. For example, if an information flow is regarded as a very high risk of being a malicious scan, the secure cloud may instruct the active agent to alter its iptables to block that information flow. In some embodiment, some of the reactions are decided by the active agent directly, depending on the timeliness of response and amount of data required to make the risk indicator assessment. Those assessments are acted on, and then reported to the secure cloud for incorporation into future versions of the user profile, as described elsewhere herein.

Notification configuration information is used by the secure cloud to determine whether a notification is required (e.g., because a risk indicator is at a certain level), to whom the notification is sent (e.g., the user, the company security team, etc.), and how the notification is to be sent (e.g., via SMS, email, automated phone call, etc.).

As will be appreciated by the skilled reader, user profile data structures in accordance with the present disclosure may contain more or less information that what is shown in FIG. 8 and FIG. 9, and may be arranged in any suitable order, provided that such user profile is configured to allow an active agent to monitor and manage information flows between endpoint devices and one or more restricted services.

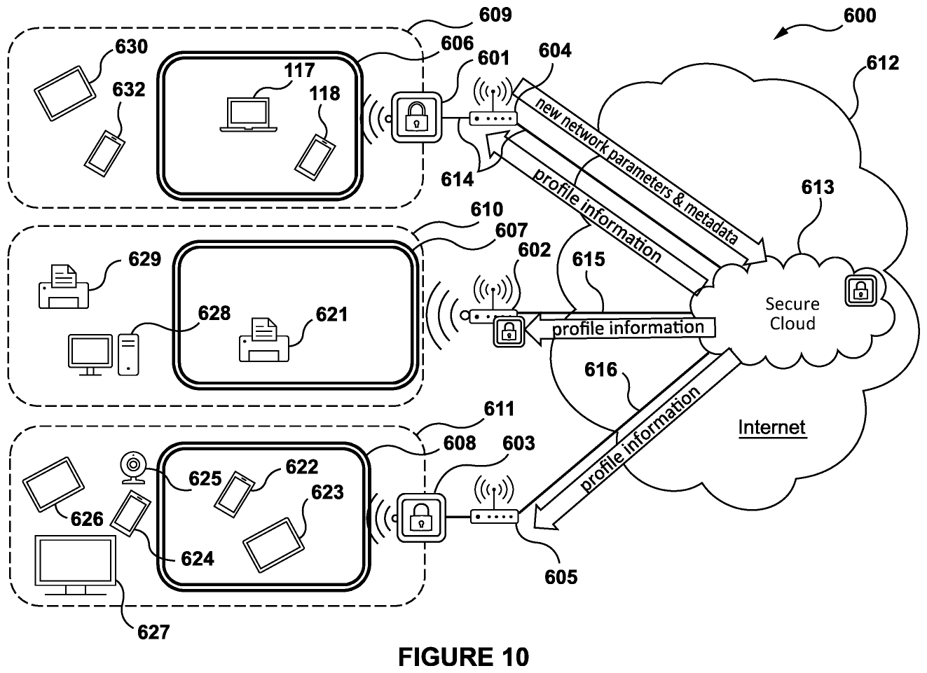

FIG. 10 shows a schematic diagram of an implementation of a system 600 in accordance with embodiments of the present disclosure. In this example, system 600 includes edge devices, 601, 602, 603 and secure cloud infrastructure 613, which is connected to of edge device 601, 602 and 603 via the internet, as disclosed in more detail elsewhere herein. The system further includes Wi-Fi networks 609, 610, 611, which may be created at different physical locations, such as a user's home, office and hotel room. For example, network 609 may be created by router 604 at a user's home, network 610 may be created by router 602 at a user's office and network 611 may be created by router 605 in a hotel room. Network 609 created by router 104 may have endpoint devices 617, 618, 630 and 632 connected thereto via, for example, a wireless communication protocol such as IEEE 802.11. Similarly, network 610 created by router 602 may have endpoint devices 628, 629, and 621 connected thereto and network 611 created by router 605 may have endpoint devices 626, 625, 624, 627, 622 and 623 connected thereto.

As will be appreciated by the skilled reader, the endpoint devices connected to wireless networks 609, 610, 611 may include any suitable endpoint device. The system 600 also includes edge devices 601, 602, 603, configured to establish isolated local networks 606, 607, 608, respectively. Isolated local networks 606, 607, 608 are created in accordance with a user profile of the user, as described in more detail elsewhere herein. Edge devices 601 and 603 may be dedicated pieces of hardware that are connected in a wired or wireless way to router 604 and 605, respectively. Non-limiting examples of edge device 601 include a wireless access points and wireless routers. Edge device 602 may be a wireless router 602, which may be provided by an Internet Service Provider (ISP).

The skilled reader will appreciate that edge devices in accordance with the present disclosure need not be of a particular type or manufacturer, provided that they have the software functionality described herein.

In the example shown in FIG. 10, edge devices 601, 602, 603 are configured to connect to a subset of the devices included in networks 609, 610, 611. In particular, edge device 601 is configured to instantiate an isolated network 606 including endpoint devices 617 and 618, exclusively, edge device 602 may be configured to instantiate an isolated network 607 including endpoint device 621, exclusively, and edge device 603 is configured to instantiate an isolated network 608 which includes endpoint devices 622 and 623, exclusively. In the embodiment shown in FIG. 10, each isolated network 606, 607, 608 is instantiated using the same user profile, and in accordance with the method described herein.

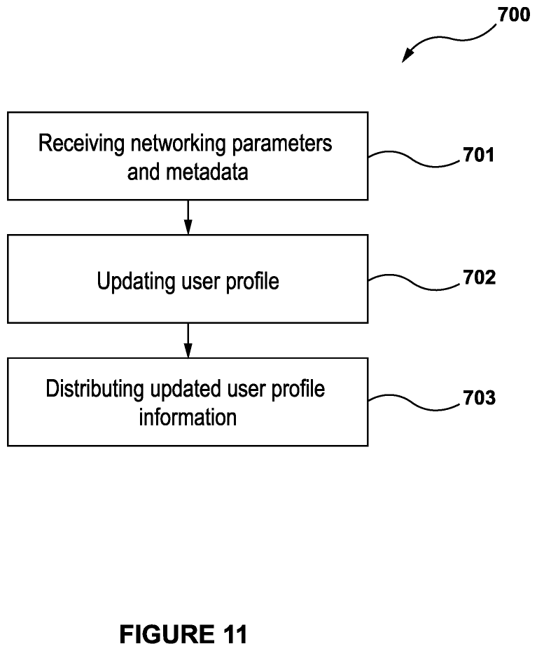

FIG. 10 and FIG. 11 show a schematic diagram of an implementation of a system in accordance with embodiments of the present disclosure and a method carried out by a system in accordance with embodiments of the present disclosure, respectively. The method shown in FIG. 11 is a method for monitoring and managing secure communications between one or more endpoint devices and one or more restricted services.

As will be appreciated by the skilled reader, an important concept of the present disclosure is that of ensuring that each active agent associated with a user is configured to monitor and manage information flows using the same user profile. As such, methods of synchronizing user profiles across active agents and edge devices 601, 602, 603 are required. In some embodiments, such methods may be carried out by secure cloud 613.

At step 701, active agent 601 collects new networking parameters and/or metadata from endpoint devices 617. An example of new parameters is information indicating that an endpoint device is acting suspiciously and must be isolated. In such a situation, that information can be incorporated into the user profile can then the user profile can be distributed to all active agents in the system. As such, if the endpoint device in question attempts to connect to an active agent running on another edge device, it will automatically be isolated. Another example of new parameters is if an active agent determines through metadata analysis that an information flow to a specific destination is video conferencing data and should therefore be prioritized. That determination can be distributed to other active agents by way of the user profile.

Then, at step 701, secure cloud 613 receives from an active agent on edge device 601, networking parameters and metadata associated with communications endpoint device 618 and a restricted service (in this example, the aforementioned server). At step 702, secure cloud 613 updates the user profile of the user of smartphone 618 using the received networking parameters and metadata.

Finally, once the user profile is updated, secure cloud 613 sends information relating to the updated user profile to each of the one or more active agents associated to that user profile, at step 703. In the example shown in FIG. 6, the updated user profile is sent to edge devices 601, 602, 603 for configuration of the active agents running on those edge device. The active agents running on edge devices 601, 602, 603 are configured to monitor and manage communications between the one or more endpoint devices and one or more restricted services using information associated with the updated user profile. Moreover, the behavioral history of information flows between smartphone 618 and the server via isolated local network 606 can be compared to the information flows happening between smartphone 618 and the server via isolated local network 606.

While the applicant's teachings described herein are in conjunction with various embodiments for illustrative purposes, it is not intended that the applicant's teachings be limited to such embodiments as the embodiments described herein are intended to be examples. On the contrary, the applicant's teachings described and illustrated herein encompass various alternatives, modifications, and equivalents, without departing from the embodiments described herein, the general scope of which is defined in the appended claims.

1. A method performed by an edge device to establish secure communication between one or more endpoint devices of a user and one or more network destinations, the method comprising:
connecting to an endpoint device of the one or more endpoint devices;
identifying the endpoint device and sending an authentication request to a user associated with the endpoint device;
receiving a user profile associated with the user, the user profile containing a plurality of networking parameters and metadata associated with the one or more endpoint devices and the one or more network destinations;
establishing an isolated local network using information associated with the user profile, the isolated local network being established between the edge device and the one or more endpoint devices; and
instantiating and configuring an active agent using information associated with the user profile to monitor and manage information flows to and from the one or more endpoint devices using information associated with the user profile.

2. The method of claim 1, wherein the method further comprises:
establishing a secure communication link using information associated with the user profile, the secure communication link being established between the edge device and one of the one or more network destinations.

3. The method of claim 1, wherein the authentication request is made by way of a secure cloud platform and a secure application running on a communication device owned by the user.

4. The method of claim 3, wherein the method further comprises:
periodically receiving updated information associated with the user profile; and
reconfiguring the active agent to monitor and manage information flows to and from the one or more endpoint devices using the updated information associated with the user profile.

5. The method of claim 1, wherein the method further comprises:
disinstantiating the active agent when none of the one or more endpoint devices are connected to the edge device for a predetermined amount of time.

6. The method of claim 1, wherein the method is performed by an active agent manager running on the edge device.

7. The method of claim 1, wherein the active agent is implemented in a virtual machine or a container on the edge device.

8. The method of claim 1, wherein the active agent is further configured to generate and collect metadata relating to information flows to and from the one or more endpoint devices.

9. The method of claim 8, wherein the metadata includes one or more of timing and volumes of information flows, source and destinations of information flows, and the types of information being communicated.

10. The method of claim 9, wherein the active agent is further configured to create risk management profiles for each of the one or more endpoint devices based on the metadata.

11. The method of claim 1, wherein the active agent is further configured to manage information flows to and from the one or more endpoint devices by routing, encrypting, filtering, and/or attenuating the information flows based on analysis of the metadata.

12. The method of claim 11, wherein the active agent is further configured to generate alerts based on the analysis of the metadata.

13. (canceled)

14. (canceled)

15. A method for monitoring and managing secure communications to and from one or more endpoint devices, the method comprising:
receiving, from one or more active agents on one or more edge devices, respectively, networking parameters and metadata associated with information flows to and from the one or more endpoint devices;
updating a user profile using the received networking parameters and metadata; and
sending information relating to the updated user profile to each of the one or more active agents, the one or more active agents being configured to monitor and manage communications to and from the one or more endpoint devices using information associated with the updated user profile.

16. The method of claim 15, wherein the one or more active agents are each implemented in a virtual machine or a container on an edge device.

17. The method of claim 15, wherein each active agent is further configured to generate and collect metadata relating to information flows to and from its respective one or more endpoint devices.

18. The method of claim 17, wherein the metadata includes one or more of timing and volumes of information flows, source and destinations of information flows, and the types of information being communicated.

19. The method of claim 18, wherein each active agent is further configured to create risk management profiles for each of the one or more endpoint devices based on the metadata.

20. The method of claim 15, wherein each active agent is further configured to manage information flows to and from the one or more end-point devices by routing, encrypting, filtering, and/or attenuating the information flows based on analysis of the metadata.

21. The method of claim 20, wherein each active agent is further configured to generate alerts based on the analysis of the metadata.

22. A system configured to:
connect to an endpoint device of one or more endpoint devices;
identify the endpoint device and send an authentication request to a user associated with the endpoint device;
receive a user profile associated with the user, the user profile containing a plurality of networking parameters and metadata associated with the one or more endpoint devices and one or more network destinations;
establish an isolated local network using information associated with the user profile, the isolated local network being established between an edge device and the one or more endpoint devices; and
instantiate and configure an active agent using information associated with the user profile to monitor and manage information flows to and from the one or more endpoint devices using information associated with the user profile.
